(19) United States
(12) Patent Application Publication
(10) Pub. No.: US 2004/0208328 A1
(43) Pub. Date: Oct. 21, 2004

(54) Portable mixing and monitoring system for musicians

(76) Inventor: Max Wayne Strother, Altamonte Springs, FL (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 10/413,833

(22) Filed: Apr. 15, 2003

(51) Int. Cl. H04B 1/00

(52) U.S. Cl. 381/119

(57) ABSTRACT

An audio monitoring and mixing system comprising a portable monitoring circuit, a breakout box, and a distribution circuit. The portable monitoring circuit includes a mixer for mixing audio signals to provide a mixed audio signal to an individual musician and a feedthrough for patching out an instrument effects signal. The breakout box includes a feedthrough circuit for distributing the first plurality of audio signals to the portable monitoring circuit and a second feedthrough for patching through the instrument effects signal from the portable monitoring circuit and providing the signal to an instrument effects processor. The distribution circuit receives audio signals and providing selected ones of the audio signals to the portable monitoring system. The system also includes a single, multi-signal cable connecting the monitoring circuit to the breakout box and a single, multi-signal cable connecting the breakout box to the distribution circuit.

### FIELD OF THE INVENTION

The present invention relates generally to audio mixers, and more particularly, to a portable audio monitor and mixer for musicians.

### BACKGROUND OF THE INVENTION

It is known in the art to provide in-the-ear monitoring systems to allow musicians to monitor audio signals as the musician is performing. Such a system may include a mixing device that is worn by the musician, for example, on a belt around the musician's hips, and includes an audio output for providing an audio signal to the musician through headphones or an ear bud. However, conventional systems of this type require the use of multiple cables and wires to accomplish in-the-ear monitoring. For example, signals from a microphone, an instrument, and a house mix may need to be provided to the musician for monitoring. As a result, the musician is encumbered by multitude of cables for providing each of these signals to musician monitoring audio signals. The resulting cabling requirements can limit the movement of the musician, and may become a tripping hazard, such as when a musician is performing on stage. Moreover, the ability for each musician to have control over the monitor mix he hears can only be accomplished by a remote mixer box. Currently, it is believed that this can only be accomplished by using multiple cables or radio transmitters and multiple mixing devices that are not worn by the musician. Furthermore, if a musician requires the use of an external effects processor, such as a guitar effects pedal, yet another cable is required to be run from the guitar to the effects pedal.

Accordingly an improved method and system for providing a portable audio monitor and mixer for musicians is needed.

### SUMMARY OF THE INVENTION

A portable audio monitoring and mixing system is described herein as including a portable monitoring circuit, adapted to be worn by a musician, for receiving and mixing audio signals and patching out an instrument effects signal. The invention may also include a breakout box for distributing the mixed audio signals and patching through an instrument effects signal. The invention may further include a distribution circuit for receiving a second group of audio signals and providing selected ones of the second group of audio signals to the portable monitoring system.

In another aspect, the invention may include a common cable comprising wires for coupling the audio signals and the instrument effects signal between the portable monitoring circuit and the breakout box. The invention may also include a second common cable comprising wires for coupling the audio signals between the distribution circuit and the breakout box.

### BRIEF DESCRIPTION OF THE DRAWINGS

The features of the invention believed to be novel are specifically set forth in the appended claims. The features and advantages of the present invention will become apparent from the following detailed description of the invention when read with the accompanying drawings in which:

FIG. 1 is a block diagram of an embodiment of the invention.

FIG. 2 is a detailed diagram of the components of the invention depicted in FIG. 1.

### DETAILED DESCRIPTION OF THE INVENTION

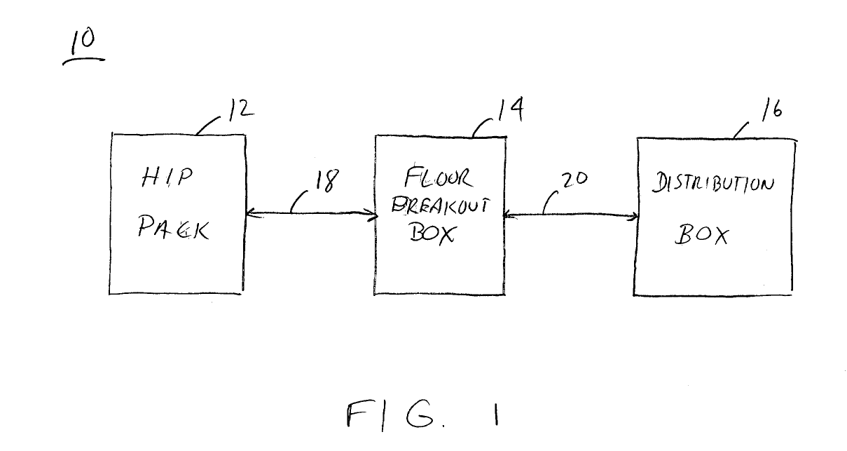

FIG. 1 is a block diagram of an embodiment of the invention. Generally, the system 10 comprises a hip pack 12, a floor breakout box 14, and a distribution box 16. The invention also includes a single multi-signal cable 18 connecting the hip pack 12 to the floor breakout box 14, and a single multi-signal cable 20 connecting the floor breakout box 14 to the distribution box 16. Accordingly, the invention resolves the problems associated with multiple cables connected to the musician's in-the-ear monitoring system, and eliminates the need to have a separate mixer box to allow the musician to control his music mix. The invention combines all audio signals, such as the musician's instrument, microphone, effects processor, and stage monitoring signals, into the single multi-signal cable 18 that attaches to a hip pack 12 worn by the musician. The hip pack 12 allows the musician to mix the audio monitoring mix that he hears, independent of other musicians, and provides connections for microphones and instruments. If a musician is utilizing a floor stand type microphone or an instrument that is stationary, the invention may include a floor breakout box 14 to allow the monitor mix to flow up the single multi-signal cable 18 to the musician's hip pack 12.

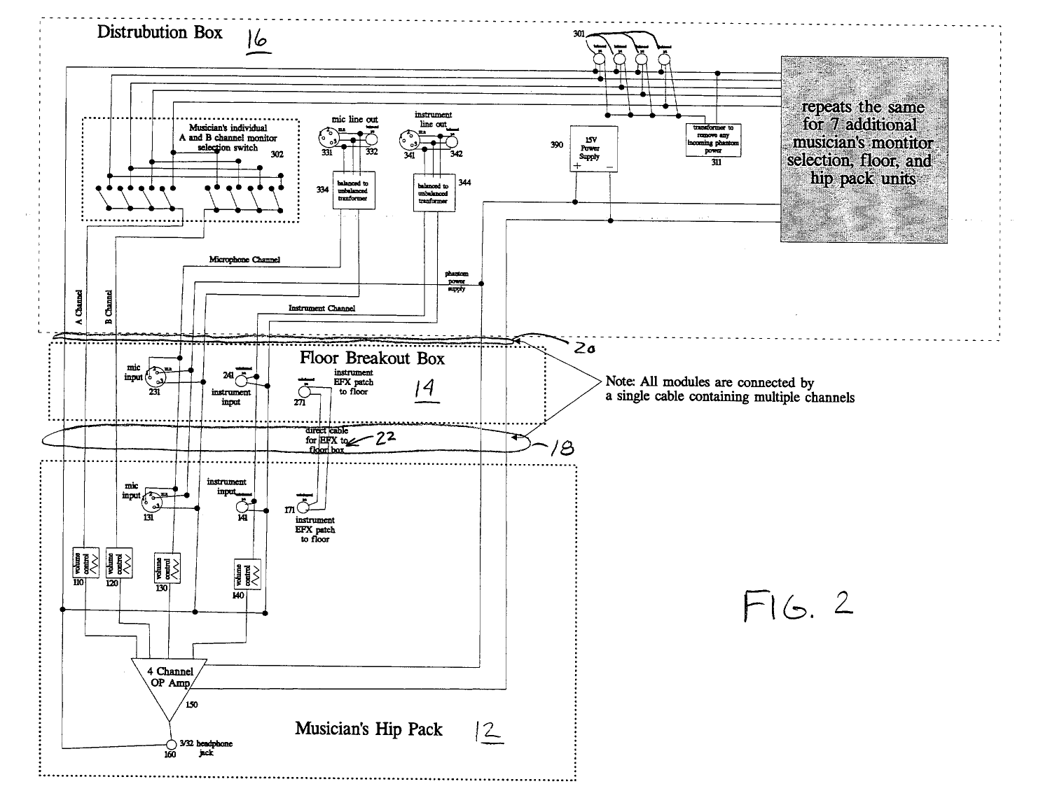

FIG. 2 is a detailed diagram of the components of the invention depicted in FIG. 1. The hip pack 12 serves several purposes. First, it serves as the volume and mixer control for in-the-ear monitoring. Second, it serves as an amplifier for an in-the-ear monitor mix. Third, it serves as a connection point for the musician's microphone and instrument. In one embodiment, the hip pack 12 contains four separate volume controls 110, 120, 130, 140 that allow the musician to independently mix into his headphones (not shown) two channels of monitor mix. In one aspect of the invention, the musician may select from four signals 301 coming from a House PA board (not shown) via the distribution box 16, as well as his instrument, and his microphone. The hip pack 12 may include a ¼ inch jack 141 for the musician's instrument that both sends the signal to the invention's monitoring feature in the Hip Pack 12 as well as back over the single multi-signal cable 18 to the floor box 14 and then to the distribution box 16 to be sent to the House PA. The hip pack 12 may also include an EFX output ¼ inch jack 171 to by-pass the hip pack 12 to send an instrument signal to a floor breakout box 14 for Effects Pedals, and an XLR mic jack 131 that sends a mic signal to both a monitor feature of the hip pack 12 and the distribution box 16 to be sent to the PA. All of these signals run thru a single multi-signal cable 18 from the musician's hip pack 12 to the floor box. No other mic or instrument cables are needed. For example, the single multi-signal cable 18 may include a shielded bundle of twisted pair wires, each twisted pair carrying a respective signal, the cable 18 including 25 pin “D” style connectors to connect to mating connectors on the hip pack 12 and breakout box 14. The hip pack 12 includes an amplifier 150 that amplifies the audio mix to a jack 160 into which the musician can plug in headphones, ear buds, or mini speakers etc.

The Floor Breakout Box 14 may be a pass thru box on the floor, positioned, for example, by the musician's feet. This box 14 serves several functions. First, it allows the musician to use a mic on a floor stand and still utilize the mic monitoring feature of the hip pack 12 without needing to plug the mic directly into the hip pack 12. The mic plugs into the floor breakout box 14. The floor breakout box 14 sends the mic signal to the single cable 18 going to the musician's hip pack 12 so that the musician can adjust the volume of his mic in the monitor mix as well as send the mic signal to the Distribution box 16 through the single cable 20 to be sent to the PA Board. A second function of the floor breakout box 14 is to allow the musician to utilize an effect processor, like a guitar pedal, and still only have one cable going from his hip to the floor. The hip pack 12 has a bypass jack 171 into which the musician plugs his/her instrument. This bypass goes directly to a ¼ inch efx out jack 271 on the floor breakout box 14. The musician then plugs his effect unit (not shown) into the ¼ inch efx out jack 171 then connects a cable (not shown) from the effects unit into the ¼ inch instrument jack 241 on the floor breakout box 14. The ¼ inch instrument jack 241 on the floor breakout box 14 is wired in parallel to the ¼ inch instrument jack 141 on the hip pack 12. Thus, floor breakout box 14 sends the ¼ inch instrument signal to both the hip pack 12 for monitoring, as well as the distribution box 16 to be sent to the PA Board. A third function of the Floor breakout box 14 is to allow the musician to plug an instrument (such as a keyboard) directly into the floor breakout box 14 instrument jack 241 to be sent to both the hip pack 12 and distribution box 16, and yet only have one cable 18 coming up to the hip pack 12 rather than have the keyboard's output cord plugging directly into the hip pack 12. The overall benefit of the Floor Breakout Box 14 is to offer the musician an input source on the floor rather than his hip pack for microphone and instrument input, as well as a way to utilize an EFX unit.

The Distribution Box 16 serves several functions. First, it receives input of, for example, four separate monitor mixes from the PA board. Second, the Distribution Box 16 distributes those four monitor inputs to eight separate switch units 302 located in the Distribution Box 16—one for each of up to, for example, eight musicians. Third, it allows each musician to select any two of the four monitor inputs to be bused to the two monitor channels in his hip unit. It should be understood that the above-described configuration is not limited to a specific number of signals, switches, or musicians. One skilled in the art could provide any number of switching and signal configurations to provide monitor signals to any number of musicians. Fourth, the Distribution Box 16 provides a regulated 15 volt plus minus power source to the hip packs 12. Fifth, it provides both balanced ¼ inch output jacks 332, 342 and balanced XLR outputs 331, 341 for both the musician's instrument and the mic to the PA system.

In an aspect of the invention, the Distribution box 16 has provision for the house PA to provide, for example, four independent audio signals 301. Each musician can then select, via switch units 302, two of the four house PA audio signals to be utilized as channel A and Channel B in his personal audio mix. The signals of Channel A and B then travel to the musician via the single multi-signal cables 18,20 that all the audio signals utilize. The musician can then independently control the audio mix of the house PA signals by adjusting volume controls 110 and 120 on the hip pack 12.

Once the musician adjusts the audio mix in the A and B channel using volume controls 110 and 120, the audio signal then goes to a amplifier 150 in the hip pack 12 where it is combined with signals from volume controls 130 and 140 (described in following paragraphs) and then on to, for example, a 3/32 inch head phone jack 160. From there, the signal travels to the musician's headphone or ear buds, etc.

In another aspect, a third source of the musician's monitor mix comes from volume control 130. Volume control 130 receives its input from one of two XLR type microphone jacks 131, 231. The first XLR jack 131 is located in the hip pack 12. The second XLR jack 231 is located in the Floor Breakout Box 14. XLR Jacks 131 and 231 are wired in parallel via the single multi-signal cable 18 that all audio signals utilize. The Jacks 131 and 231 allow the microphone to be plugged into either jack 131 on the hip pack 12 or jack 231 on the Floor Breakout Box 14. Because the signal from 131 or 231 travels to both volume control 130 as well as to output jack 331 or 332 located in the Distribution Box 16, the musician can mix the volume of the microphone signal via volume control 130 to his in-the-ear monitor even if a floor mic is used. Transformer 334 converts the unbalanced signal to a balanced signal before it exits the Distribution Box 16 via 331 or 332 to the House PA. Once the musician adjusts the audio mix by adjusting the volume control 130, the audio signal then goes to a amplifier 150 in the hip pack 12 where it is combined with signals from volume controls 110, 120, and 140 and then on to the 3/32 inch head phone jack 160. From there the signal travels to the musician's headphone or ear buds, etc.

Another source of the musician's monitor mix comes from volume control 140. Volume control 140 receives its input from one of two ¼ inch jacks 141, 241. The first jack 141 is located in the hip pack 12. The second jack 241 is located in the Floor Breakout Box 14. Jacks 141 and 241 are wired in parallel via the single multi-signal cable 18 that all audio signals utilize. The jacks 141 and 241 allow an instrument to be plugged into either jack 141 on the hip pack 12 or jack 241 on the Floor Breakout Box 14. Because the signal from jacks 141 or 241 travel to both volume control 140 as well as to output jack 341 or 342 located in the Distribution Box 16, the musician can mix the volume of the musical instrument signal via volume control 140 to his in-the-ear monitor even if a floor type instrument is use. Transformer 344 converts the unbalanced signal to a balanced signal before it exits the Distribution Box 16 via 341 or 342 to the House PA. Once the musician adjusts the audio mix by adjusting the volume control 140, the audio signal then goes to a amplifier 150 in the hip pack 12 where it is combined with signals from volume control 110, 120 and 140 and then on to the 3/32 head phone jack 160. From there the signal travels to the musician's headphone, ear buds, etc.

An important aspect of the invention is the utilization of single cables that contain multi-signal signals to connect all components of the system. In another embodiment, an EFX Patch 22, utilizing ¼ inch jacks 171 and 271, is included between the Hip Pack 12 and the Floor Breakout Box 14. The EFX Patch 22 is a simple single channel connection. The EFX patch 22 allows a musician to plug an electric guitar into hip pack jack 171. The signal from the guitar travels to the hip pack 12 jack 171, then to the Floor Breakout Box 14 via the single multi-signal cable 18 to jack 271. The musician then can attach the input cable from an EFX unit to jack 271. Then, the output cable (not shown) of the musician's EFX unit would be plugged into Floor Breakout Box 14 instrument channel jack 241. The signal from the musicians EFX unit then would travel in two directions. One direction is up the single multi-signal cable to the Hip Pack 12 to volume control 130. The other direction is down the instrument channel in the single multi-signal cable 18 to output jacks 341 and 342 in the Distribution Box 16 to then be outputted to the House PA.

The Distribution box 16 utilizes a transformer 311 to remove any Phantom Power source coming from the house PA. Phantom power is an industry acceptable way for a House PA to supply up to 48V on an audio cable to power some microphones that require a battery power source. This invention removes any incoming Phantom Power via transformer 311 so the House PA supplied 48 volts does not overwhelm the audio signals flowing through the system. In an aspect of the invention, the house PA Phantom Power is replaced with an independent Power supply 390 for powering the system. Power for Amplifier 150 in the hip pack is supplied via the single multi-signal cables 18, 20 from the power supply 311 in the Distribution Box 16. Accordingly, the Distribution Box serves as the input and output from the invention to the House PA equipment as well as a location to house the Power Supply 390 and the Musicians Channel selection switch 302.

While only certain preferred features of the invention have been shown by way of illustration, many modifications and changes will occur to those skilled in the art. It is, therefore, to be understood that the present claims are intended to cover all such modifications and changes, which fall within the true spirit of the invention.

What is claimed is:

1. An audio monitoring system comprising:
a portable monitoring circuit comprising a mixer for mixing a first plurality of audio signals to provide a mixed audio signal, and a first feedthough for patching out an instrument effects signal; and
a breakout box comprising a feedthrough circuit for distributing the first plurality of audio signals to the portable monitoring circuit and a second feedthrough for patching the instrument effects signal from the portable monitoring circuit and providing the signal to an instrument effects processor.

3. The system of claim 2, further comprising a conditioning circuit for receiving at least one of the first plurality of audio signals and providing a corresponding balanced audio output signal.

4. The system of claim 1, further comprising a first common cable comprising a plurality of wires for coupling the first plurality of audio signals between the breakout box and the portable monitoring circuit.

5. The system of claim 4, the first common cable further comprising a plurality of wires for coupling an instrument effects signal between the portable monitoring circuit and the breakout box.

6. The system of claim 1, further comprising a second common cable comprising a plurality of wires for coupling the first plurality of audio signals from the distribution circuit to the breakout box.

7. The system of claim 1, the portable monitoring circuit further comprising respective volume control circuits, coupled to each of the first plurality of audio signals, for controlling the volume levels of each of the first plurality of audio signals.

8. The system of claim 1, the first plurality of audio signals comprising at least two monitor signals, a microphone signal, an instrument signal, and a power signal.

9. A portable audio monitoring and mixing system comprising:
a portable monitoring circuit, adapted to be worn by a musician, for receiving and mixing a plurality of audio signals and patching out an instrument effects signal;
a breakout box for distributing the plurality of mixed audio signals and patching through an instrument effects signal; and
a distribution circuit for receiving a second plurality of audio signals and providing selected ones of the second plurality of audio signals to the portable monitoring system.

10. The system of claim 9, further comprising:
a first common cable comprising a plurality of wires for coupling the first plurality of audio signals and the instrument effects signal between the portable monitoring circuit and the breakout box; and
a second common cable comprising a plurality of wires for coupling the first plurality of audio signals between the distribution circuit and the breakout box.
